(19) United States
(12) Patent Application Publication
(10) Pub. No.: US 2013/0166052 A1
(43) Pub. Date: Jun. 27, 2013

(54) TECHNIQUES FOR IMPROVING PLAYBACK OF AN AUDIO STREAM

(71) Applicants: Vamshi Kadiyala, Bangalore (IN); Abid Mullah, Folsom, CA (US)

(72) Inventors: Vamshi Kadiyala, Bangalore (IN); Abid Mullah, Folsom, CA (US)

(21) Appl. No.: 13/337,951

(22) Filed: Dec. 27, 2011

(51) Int. Cl. G06F 17/00

(52) U.S. Cl. 700/94

(57) ABSTRACT

Techniques to improve playback of an audio stream are described. In one embodiment, for example, an management module may be operable by a processor circuit to receive a notification of a pending delivery of encoded audio data, and transmit a silent audio stream after receiving the notification. Other embodiments are described and claimed.

### BACKGROUND

Audio playback generally involves transmission of audio data from an audio source, which generates the audio data, to an audio receiver, which produces sound based on the audio data. In many situations, audio data that is generated in one format may need to be converted to a different format in order for sound to be produced based on the audio data. Under such circumstances, there may be a latency period associated with time that elapses while the conversion is performed. Additional latency may be associated with time that elapses while the audio data is in transit.

Many audio receiver devices are designed to power down portions of their circuitry when audio data is not being received. For example, if audio data is not being received during a latency period, an audio receiver may power down one or more portions of its circuitry. However, this may result in a loss of some initial parts of the audio data upon receipt. Additionally, powering circuitry off and on may increase power consumption on the part of the audio receiver. Consequently, techniques designed to improve playback of an audio stream are desirable.

### BRIEF DESCRIPTION OF THE DRAWINGS

FIG. 1 illustrates one embodiment of an apparatus and one embodiment of a first system.

FIG. 2 illustrates one embodiment of a state diagram.

FIG. 3 illustrates one embodiment of a logic flow.

FIG. 4 illustrates one embodiments of a transmission diagram.

FIG. 5 illustrates one embodiment of a second system.

FIG. 6 illustrates one embodiment of a third system.

FIG. 7 illustrates one embodiment of a device.

### DETAILED DESCRIPTION

Various embodiments may be generally directed to techniques for improving playback of an audio stream. In one embodiment, for example, an apparatus may comprise a processor circuit and an audio management module, and the audio management module may be operable by the processor circuit to receive a notification of a pending delivery of encoded audio data, transmit a silent audio stream after receiving the notification, receive the encoded audio data, decode the encoded audio data, and transmit the decoded audio data. In this manner, audio data loss at a receiver of the audio stream may be reduced, and power savings may be realized. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

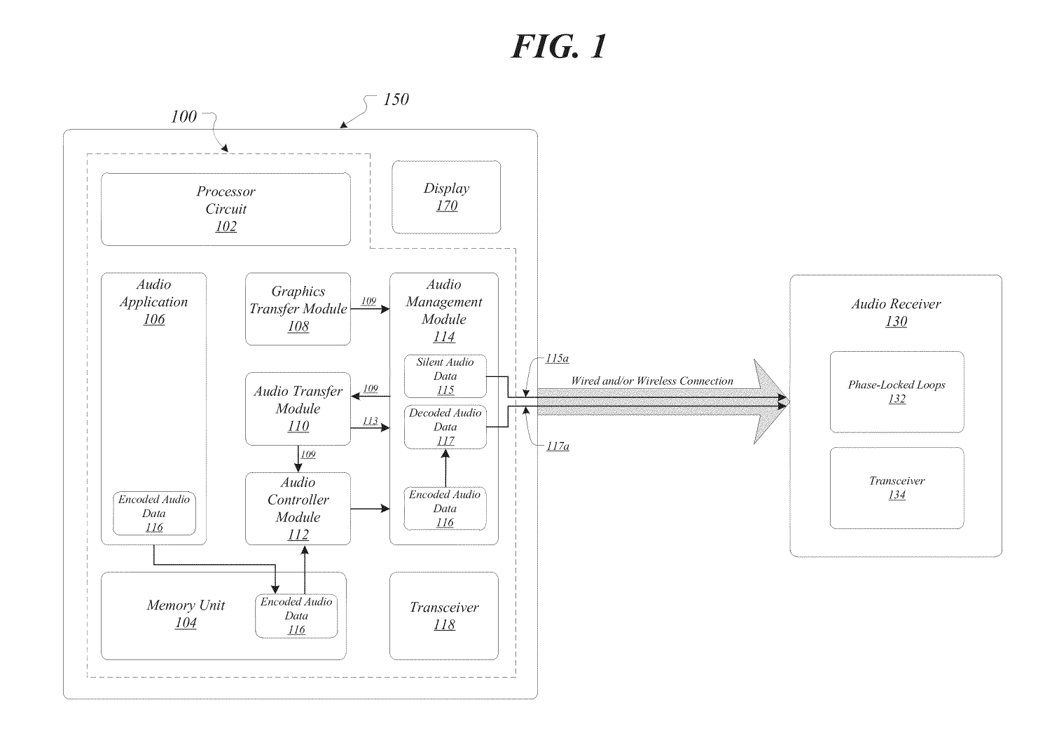

FIG. 1 illustrates a block diagram of an apparatus 100. As shown in FIG. 1, apparatus 100 comprises multiple elements including a processor circuit 102, a memory unit 104, an audio application 106, a graphics transfer module 108, an audio transfer module 110, an audio controller module 112, an audio management module 114, and a transceiver 118. In one embodiment, the apparatus 100 may be implemented in an electronic device, which optionally includes an audio receiver 130 integrated into the single electronic device. Alternatively, the apparatus 100 and the audio receiver 130 may be implemented in separate electronic devices, and communicate with each other using wired or wireless communications techniques. The embodiments, however, are not limited to the type, number, or arrangement of elements shown in this figure.

In various embodiments, apparatus 100 may comprise processor circuit 102. Processor circuit 102 may be implemented using any processor or logic device, such as a complex instruction set computer (CISC) microprocessor, a reduced instruction set computing (RISC) microprocessor, a very long instruction word (VLIW) microprocessor, an x86 instruction set compatible processor, a processor implementing a combination of instruction sets, a multi-core processor such as a dual-core processor or dual-core mobile processor, or any other microprocessor or central processing unit (CPU). Processor circuit 102 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor, an application specific integrated circuit (ASIC), a field programmable gate array (FPGA), a programmable logic device (PLD), and so forth. In one embodiment, for example, processor circuit 102 may be implemented as a general purpose processor, such as a processor made by Intel® Corporation, Santa Clara, Calif. The embodiments are not limited in this context.

In some embodiments, apparatus 100 may comprise a memory unit 104 communicatively coupled to processor circuit 102. Memory unit 104 may be implemented using any machine-readable or computer-readable media capable of storing data, including both volatile and non-volatile memory. For example, memory unit 104 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory unit 104 may be included on the same integrated circuit as processor circuit 102, or alternatively some portion or all of memory unit 104 may be disposed on an integrated circuit or other medium, for example a hard disk drive, that is external to the integrated circuit of processor circuit 102. The embodiments are not limited in this context.

In various embodiments, processor circuit 102 may be operable to execute an audio application 106. Audio application 106 may comprise any application featuring audio capabilities, such as, for example, an application program, a system program, a conferencing application, a gaming application, a productivity application, a messaging application, an instant messaging (IM) application, an electronic mail (email) application, a short messaging service (SMS) application, a multimedia messaging service (MMS) application, a social networking application, a web browsing application, and so forth. The embodiments, however, are not limited in this respect. While executing, audio application 106 may be operative to generate encoded audio data 116 that represents tones, music, speech, speech utterances, sound effects, background noise, or other sounds. Encoded audio data 116 may be in a particular audio format, the audio format comprising a sampling frequency, a sampling length, and/or one or more other parameters. The audio application 106 may be operative to load memory unit 104 with encoded audio data 116.

In some embodiments, apparatus 100 may comprise a graphics transfer module 108. Graphics transfer module 108 may comprise a graphics driver in some embodiments. Examples for graphics transfer module 108 may include but are not limited to a graphics driver microchip or card, graphics driver circuitry integrated into a multi-purpose microchip or card, and a graphics driver implemented as software. The embodiments, however, are not limited to this example.

In various embodiments, apparatus 100 may comprise an audio transfer module 110. Audio transfer module 110 may comprise an audio driver in some embodiments. Examples for audio transfer module 110 may include but are not limited to an audio driver microchip or card, audio driver circuitry integrated into a multi-purpose microchip or card, and an audio driver implemented as software. In some embodiments, audio transfer module 110 may be included on a same integrated circuit or chipset as graphics transfer module 108. The embodiments, however, are not limited to this example.

In various embodiments, apparatus 100 may comprise an audio controller module 112. Audio controller module 112 may comprise an audio controller in various embodiments. Examples for audio controller module 112 may include an audio controller microchip or card, an audio controller integrated into a multi-purpose microchip or card, and an audio controller implemented as software. In various embodiments, audio controller module 112 may comprise a high definition (HD) audio controller. In one embodiment, for example, audio controller module 112 may be implemented using an HD audio controller integrated onto a motherboard for a computing device. The embodiments, however, are not limited in this respect.

In various embodiments, apparatus 100 may comprise an audio management module 114. Audio management module 114 may comprise an audio coder/decoder (codec) in some embodiments. Examples for audio management module 114 may include an audio codec microchip or card, an audio codec integrated into a multi-purpose microchip or card, and an audio codec implemented as software. In various embodiments, audio management module 114 may comprise an HD audio codec that complies with Intel High Definition Audio Specification, Revision 1.0a (2010). In one embodiment, for example, audio management module 114 may be implemented using an HD audio codec integrated into a Platform Controller Hub (PCH) microchip made by Intel® Corporation, Santa Clara, Calif. Other embodiments are described and claimed.

In various embodiments, apparatus 100 may comprise a transceiver 118. Transceiver 118 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 118 may operate in accordance with one or more applicable standards in any version. The embodiments are not limited in this context.

FIG. 1 also illustrates a block diagram of a system 150. System 150 may comprise any of the aforementioned elements of apparatus 100. System 150 may further comprise a display 170. Display 170 may comprise any display device capable of displaying information received from processor circuit 102. Examples for display 170 may include a television, a monitor, a projector, and a computer screen. In one embodiment, for example, display 170 may be implemented by a liquid crystal display (LCD), light emitting diode (LED) or other type of suitable visual interface. Display 170 may comprise, for example, a touch-sensitive color display screen. In various implementations, display 170 may comprise one or more thin-film transistors (TFT) LCD including embedded transistors. In various embodiments, display 170 may be arranged to display a graphical user interface operable to directly or indirectly control audio application 106. For example, in some embodiments, display 170 may be arranged to display a graphical user interface generated by audio application 106. In such embodiments, the graphical user interface may enable operation of audio application 106 to generate encoded audio data 116. The embodiments, however, are not limited to these examples.

In some embodiments, audio management module 114 may be configured based on capabilities of audio receiver 130. Audio receiver 130 may comprise any device capable of generating tones, music, speech, speech utterances, sound effects, background noise, or other sounds based on received audio data. Examples of audio receiver 130 may include a speaker, a multi-speaker system, a home entertainment system, a television, a media set top box (STB), a digital video recorder (DVR), a consumer appliance, a computer system, a mobile device, and a portable electronic media device, among other examples. Capabilities of audio receiver 130 may include compatibility with various audio sampling frequencies and lengths. In various embodiments, audio receiver 130 may comprise one or more electronic components, such as one or more phase-locked loops (PLLs) 132 that are used to time the playback of received audio data. Audio receiver 130 may be configurable to communicatively couple with apparatus 100 and/or system 150. In some such embodiments, audio receiver 130 may be configurable to receive data from apparatus 100 and/or system 150 over a wired connection, a wireless connection, or both. In some embodiments, audio receiver 130 may comprise a transceiver 134, and apparatus 100 and/or system 150 may implement a wireless connection with audio receiver 130 via transceiver 134, using transceiver 118. The embodiments are not limited in this context.

In general operation, apparatus 100 and/or system 150 may be operative to perform transmission of audio data to audio receiver 130. In various embodiments, apparatus 100 and/or system 150 may be operative to perform transmission of audio data in the form of an audio stream. In some embodiments, an audio stream may comprise a sequence of audio samples, and each of the audio samples may comprise a plurality of audio data bits. Audio receiver 130 may convert the audio data bits in the audio samples of the received audio stream into tones, music, speech, speech utterances, sound effects, background noise, or other sounds. In various embodiments, the audio stream may be an HD audio stream.

In various embodiments, apparatus 100 and/or system 150 may be operative to transmit audio data to audio receiver 130 based on instructions from audio application 106. In some such embodiments, audio transfer module 110 may be wakened when audio application 106 is launched. For example, when audio application 106 is launched, processor circuit 102 may cause graphics transfer module 108 to send a presence detect event 109 to audio management module 114, which may be communicatively coupled audio transfer module 110. Presence detect event 109 may comprise any programming logic, code, information, or data that is operative to notify audio management module 114, audio transfer module 110, and/or audio controller module 112 that audio receiver 130 is communicatively coupled to apparatus 100 and/or system 150, and/or that audio application 106 has been launched and may generate encoded audio data 116. Audio management module 114 may pass presence detect event 109 to audio transfer module 110 in order to wake audio transfer module 110. Audio transfer module 110 may then pass presence detect event 109 to audio controller module 112, or audio controller module 112 may receive presence detect event 109 from one or more other components of apparatus 100 and/or system 150. It is worthy of note that although FIG. 1 shows audio controller module 112 receiving presence detect event 109 from audio transfer module 110, the embodiments are not limited to this example, and as noted above, audio controller module 112 may receiver presence detect event 109 from audio management module 114, graphics transfer module 108, and/or other components of apparatus 100 and/or system 150.

In order to cause apparatus 100 and/or system 150 to transmit audio data to audio receiver 130, audio application 106 may be operative to store encoded audio data 116 in memory unit 104, and alert audio transfer module 110 that the encoded audio data 116 has been stored in memory unit 104. In response, audio transfer module 110 may be operative to initiate a pending delivery of encoded audio data 116 from memory unit 104 to audio management module 114, and to transmit to audio management module 114 a notification 113 of the pending delivery of the encoded audio data 116. In various embodiments, encoded audio data 116 may comprise digital audio data. The embodiments, however, are not limited to these examples.

In some embodiments, apparatus 100 and/or system 150 may need to adjust its transmission of audio data to audio receiver 130 in order to account for limitations of audio receiver 130. For example, the PLLs 132 in audio receiver 130 may be operable to enter an active state when audio data is being received, and a sleep state when no audio data is being received. Under such circumstances, the PLLs 132 may exit an active state and enter a sleep state if there is a latency period in the audio data transmitted by apparatus 100 and/or system 150, during which no audio data is transmitted.

Permitting the PLLs 132 to enter the sleep state may be undesirable for multiple reasons. In some embodiments, the PLLs 132 may be operable to exit the sleep state upon receipt of audio data, but some initial portion of the audio data that “wakes up” the PLLs 132 may be lost in the process, resulting in incomplete audio playback. Also, in various embodiments, excessive cycling between active states and sleep states may cause the PLLs 132 to consume significant amounts of power. To solve these and other problems, apparatus 100 and/or system 150 may be operative to adjust its transmission of audio data to prevent or reduce PLLs 132 at audio receiver 130 from entering sleep states. For example, apparatus 100 and/or system 150 may be arranged to transmit silent audio data 115 as a silent audio data stream 115a during a latency period in the audio data. Silent audio data 115 may comprise a sequence of audio samples that, when transmitted as silent audio data stream 115a and processed at audio receiver 130, prevents PLLs 132 from entering sleep states, but does not cause audio receiver 130 to produce tones, music, speech, speech utterances, sound effects, background noise, or other sounds. In various embodiments, silent audio data 115 may comprise a sequence of audio samples wherein each of the audio samples in the sequence represents silence. For example, in some embodiments in which the audio samples comprise audio data bits, silence may be represented by setting all of the audio data bits in an audio sample to zero. The embodiments, however, are not limited in this respect.

Upon receiving silent audio data stream 115a, audio receiver 130 may maintain PLLs 132 in an active state, or transition PLLs 132 from a sleep state into an active state, based on the fact that audio data is being received. However, because the audio data being received comprises a silent stream, processing of silent audio data stream 115a may not cause audio receiver 130 to produce tones, music, speech, speech utterances, sound effects, background noise, or other sounds. In this manner, apparatus 100 and/or system 150 may be arranged to maintain PLLs 132 at audio receiver 130 in an active state during the latency period, thereby preventing loss of audio data and reducing power consumption.

For example, in various embodiments, after receiving from audio transfer module 110 the notification 113 of the pending delivery of encoded audio data 116, audio management module 114 may transmit silent audio data stream 115a to audio receiver 130. In some such embodiments, audio management module 114 may transmit silent audio data stream 115a to audio receiver 130 over a wired connection between apparatus 100 and/or system 150 and audio receiver 130. In other such embodiments, audio management module 114 may transmit silent audio data stream 115a to audio receiver 130 wirelessly, using transceiver 118. Silent audio data stream 115a may comply with an audio cadence protocol of audio management module 114. The audio cadence protocol may be specified by a particular audio standard, and may define constraints on transmission parameters for audio data streams corresponding to various audio data formats. For example, the audio cadence protocol may be specified according to Intel High Definition Audio Specification, Revision 1.0a (2010), and may define how much audio data should be transmitted per unit time for an audio format according to which audio management module 114 has generated silent audio data stream 115a. In some embodiments, when audio receiver 130 receives silent audio data stream 115a, PLLs 132 in audio receiver 130 may leave a sleep state and enter an active state. In other embodiments, when audio receiver 130 receives silent audio data stream 115a, PLLs 132 in audio receiver 130 may not yet have entered a sleep state, and receipt of silent audio data stream 115a will cause PLLs 132 to maintain a current active state and forgo entry into a sleep state.

In some embodiments, audio management module 114 may be operative to receive and decode encoded audio data 116 to form decoded audio data 117, in the audio format corresponding to encoded audio data 116. In some of these embodiments, encoded audio data 116 may be delivered from memory unit 104 to audio management module 114 through audio controller module 112, and audio management module 114 may be operative to receive encoded audio data 116 from audio controller module 112. In other embodiments, audio management module 114 may be operative to receive encoded audio data 116 directly from memory unit 104. Audio management module 114 may be operative to transmit silent audio data stream 115a to audio receiver 130 during part or all of the period during which it receives and decodes encoded audio data 116. After decoding encoded audio data 116 to obtain decoded audio data 117, audio management module 114 may be operative to transmit decoded audio data 117 to audio receiver 130 as decoded audio data stream 117a. It is worthy of note that although FIG. 1 illustrates silent audio data stream 115a and decoded audio data stream 117a as departing from audio management module 114 on two separate data lines, the embodiments are not limited to this arrangement. Silent audio data stream 115a and decoded audio data stream 117a may depart audio management module 114 on the same data line or separate data lines. Furthermore, silent audio data stream 115a and decoded audio data stream 117a may depart audio management module 114 on a combination of multiple data lines where none or only some of the data lines are dedicated to silent audio data stream 115a or decoded audio data stream 117a. Likewise, silent audio data stream 115a and decoded audio data stream 117a may be transmitted to audio receiver 130 over the same wired and/or wireless connection, different wired and/or wireless connections, or using any combination of multiple wired and/or wireless connections. The embodiments are not limited in this context.

In some embodiments, generation of encoded audio data 116 by audio application 106 may be preceded by a period during which audio application 106 does not generate audio data, and a latency period may begin when audio application 106 begins generating encoded audio data 116. In various embodiments, PLLs 132 in audio receiver 130 may have been maintained in an active state by transmission of a previous silent audio data stream, and a new silent audio data stream may be transmitted during the latency period to maintain PLLs 132 in the active state. In other embodiments, PLLs 132 in audio receiver 130 may have entered a sleep state, and silent audio data stream 115a may be transmitted during the latency period to cause PLLs 132 to exit the sleep state and enter an active state.

In other embodiments, generation of encoded audio data 116 by audio application 106 may be preceded by a period during which audio application 106 generates previous encoded audio data in a previous audio format that differs from the audio format of encoded audio data 116. In such embodiments, a latency period may begin when audio application 106 ceases generating the previous encoded audio data. In such embodiments, PLLs 132 in audio receiver 130 may be in an active state at the beginning of the latency period, due to receipt of a previous decoded audio data stream comprising previous decoded audio data obtained by decoding the previous encoded audio data, and silent audio data stream 115a may be transmitted during the latency period to maintain PLLs 132 in the active state.

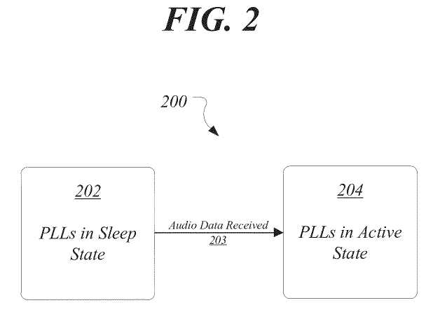

FIG. 2 comprises a state diagram 200, which illustrates a transition of PLLs 132 from a sleep state 202 to an active state 204. PLLs 132 begin in sleep state 202. At transition 203, audio data is received by PLLs 132, causing them to transition to active state 204.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

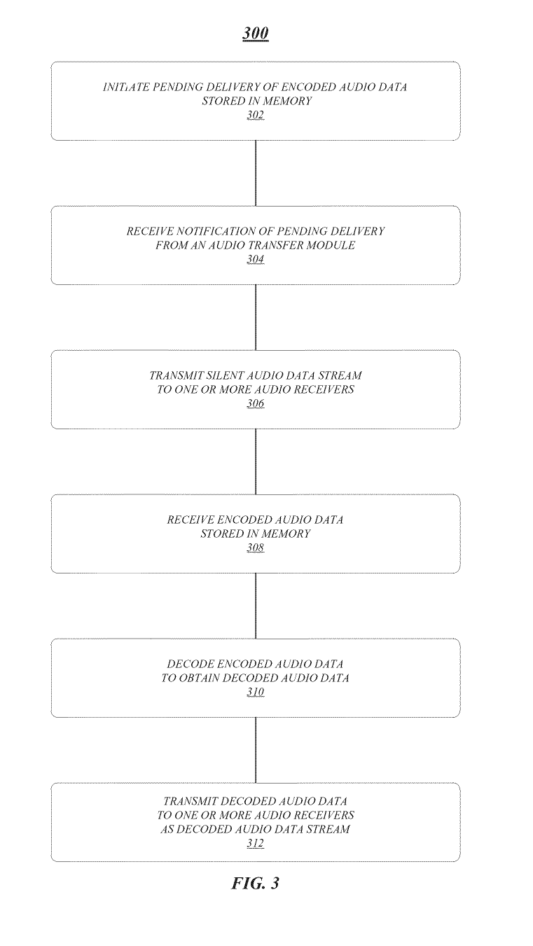

FIG. 3 illustrates one embodiment of a logic flow. FIG. 3 illustrates a logic flow 300. Logic flow 300 may be representative of the operations executed by one or more embodiments described herein. As shown in logic flow 300, a pending delivery of encoded audio data may be initiated at 302. For example, audio transfer module 110 of FIG. 1 may be alerted that encoded audio data 116 has been stored in memory unit 104, and initiate a pending delivery of encoded audio data 116 from memory unit 104 to audio management module 114. At 304, notification of the pending delivery of encoded audio data may be received. For example, audio management module 114 of FIG. 1 may receive a notification 113 of a pending delivery of encoded audio data 116 from audio transfer module 110, which may be an audio driver in various embodiments. At 306, a silent audio data stream may be transmitted to one or more audio receivers. For example, after receiving notification 113 of the pending delivery of encoded audio data 116, audio management module 114 of FIG. 1 may transmit silent audio data stream 115a to audio receiver 130. At 308, the encoded audio data may be received. For example, audio management module 114 of FIG. 1 may receive encoded audio data 116 from audio controller module 112, or may receive encoded audio data 116 directly from memory unit 104. At 310, the encoded audio data may be decoded to obtain decoded audio data. For example, audio management module 114 of FIG. 1 may decode encoded audio data 116 to form decoded audio data 117 in an audio format corresponding to the encoded audio data 116. At 312, the decoded audio data may be transmitted to the one or more audio receivers as a decoded audio data stream. For example, audio management module 114 of FIG. 1 may transmit decoded audio data 117 to audio receiver 130 as decoded audio data stream 117a.

In some embodiments, a previous audio data stream may be transmitted to the one or more audio receivers prior to receiving the notification of the pending delivery of encoded audio data. The previous audio data stream may be in a previous audio format that differs from that of the silent audio data stream that is transmitted upon receiving the notification. In various embodiments, the previous audio data stream may comprise a previous silent audio data stream. In others of such embodiments, the previous audio stream may comprise a previous decoded audio data stream.

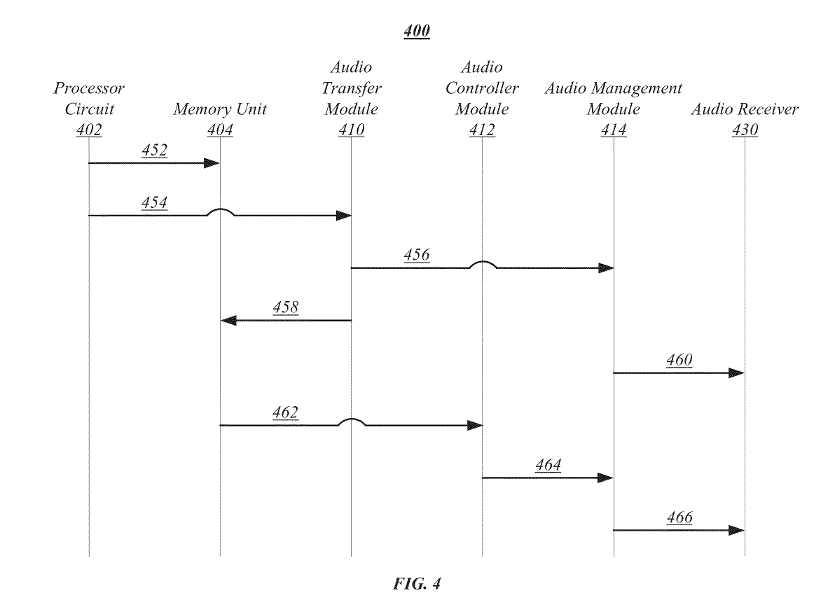

FIG. 4 illustrates one embodiment of a transmission diagram 400. In various embodiments, transmission diagram 400 may include a sequence of transmissions that may be performed in conjunction with one embodiment of a method for improving playback of an audio stream. At 452, a processor circuit 402 may transmit encoded audio data to a memory unit 404. For example, processor circuit 102 of FIG. 1 may transmit encoded audio data 116 to memory unit 104. At 454, the processor circuit 402 may transmit instructions to an audio transfer module 410 to initiate a transfer of the encoded audio data. For example, processor circuit 102 of FIG. 1 may alert audio transfer module 110 that encoded audio data 116 has been stored in memory unit 104, and initiate a pending delivery of encoded audio data 116 from memory unit 104 to audio management module 114. In some embodiments, audio transfer module 410 may be an audio driver. At 456, audio transfer module 410 may transmit a notification of the pending transfer to an audio management module 414. For example, audio transfer module 110 of FIG. 1 may transmit notification 113 of a pending delivery of encoded audio data 116 to audio management module 114. At 458, audio transfer module 410 may transmit a request for the encoded audio data to the memory unit 404. For example, audio transfer module 110 of FIG. 1 may transmit a request for the encoded audio data 116 to memory unit 104. At 460, audio management module 414 may transmit a silent audio data stream to an audio receiver 430. For example, after receiving notification 113 of the pending delivery of encoded audio data 116, audio management module 114 of FIG. 1 may transmit silent audio data stream 115 to audio receiver 130. At 462, the encoded audio data may be transmitted from memory unit 404 to an audio controller module 412. For example, encoded audio data 116 may be delivered to audio controller module 112 of FIG. 1 from memory unit 104. At 464, audio controller module 412 may transmit the encoded audio data to audio management module 414. For example, audio controller module 112 of FIG. 1 may transmit encoded audio data 116 to audio management module 114. At 466, audio management module 414 may transmit decoded audio data to audio receiver 430, the decoded audio data obtained by decoding the encoded audio data received at 464. For example, audio management module 114 of FIG. 1 may receive encoded audio data 116 from audio controller module 112, decode encoded audio data 116 to form decoded audio data 117, and transmit decoded audio data 117 to audio receiver 130. The embodiments are not limited to this example.

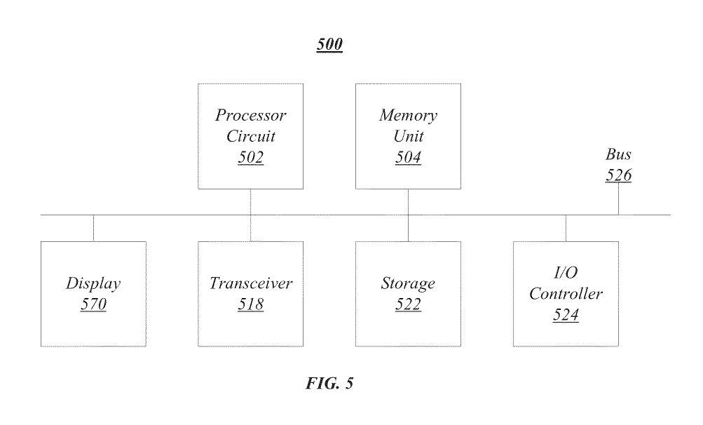

FIG. 5 illustrates one embodiment of a system 500. In various embodiments, system 500 may be operable to execute instructions for improving playback of an audio stream. System 500 may be representative of a system or architecture suitable for use with one or more embodiments described herein, such as apparatus 100 and/or system 150 of FIG. 1, state diagram 200 of FIG. 2, logic flow 300 of FIG. 3, or transmission diagram 400 of FIG. 4. The embodiments are not limited in this respect.

As shown in FIG. 5, system 500 may comprise multiple elements. One or more elements may be implemented using one or more circuits, components, registers, processors, software subroutines, modules, or any combination thereof, as desired for a given set of design or performance constraints. Although FIG. 5 shows a limited number of elements in a certain topology by way of example, it can be appreciated that more or less elements in any suitable topology may be used in system 500 as desired for a given implementation. The embodiments are not limited in this context.

In various embodiments, system 500 may include a processor circuit 502. Processor circuit 502 may be implemented using any processor or logic device, and may be the same as or similar to processor circuit 102 of FIG. 1.

In one embodiment, system 500 may include a memory unit 504 to couple to processor circuit 502. Memory unit 504 may be coupled to processor circuit 502 via communications bus 526, or by a dedicated communications bus between processor circuit 502 and memory unit 504, as desired for a given implementation. Memory unit 504 may be implemented using any machine-readable or computer-readable media capable of storing data, including both volatile and non-volatile memory and may be the same as or similar to memory unit 104 of FIG. 1.

In various embodiments, system 500 may include a transceiver 518. Transceiver 518 may include one or more radios capable of transmitting and receiving signals using various suitable wireless communications techniques, and may be the same as or similar to transceiver 118 of FIG. 1. Such techniques may involve communications across one or more wireless networks. In communicating across such networks, transceiver 518 may operate in accordance with one or more applicable standards in any version. The embodiments are not limited in this context.

In various embodiments, system 500 may include storage 522. Storage 522 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 522 may comprise technology to increase the storage performance enhanced protection for valuable digital media when multiple hard drives are included, for example. Further examples of storage 522 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, system 500 may include one or more I/O adapters 524. Examples of I/O adapters 524 may include Universal Serial Bus (USB) ports/adapters, IEEE 1394 Firewire ports/adapters, and so forth. The embodiments are not limited in this context.

In various embodiments, system 500 may include a display 570. Display 570 may comprise any television type monitor or display. Display 570 may comprise any display device capable of displaying information received from processor circuit 502, and may be the same as or similar to display 170 of FIG. 1. The embodiments are not limited in this context.

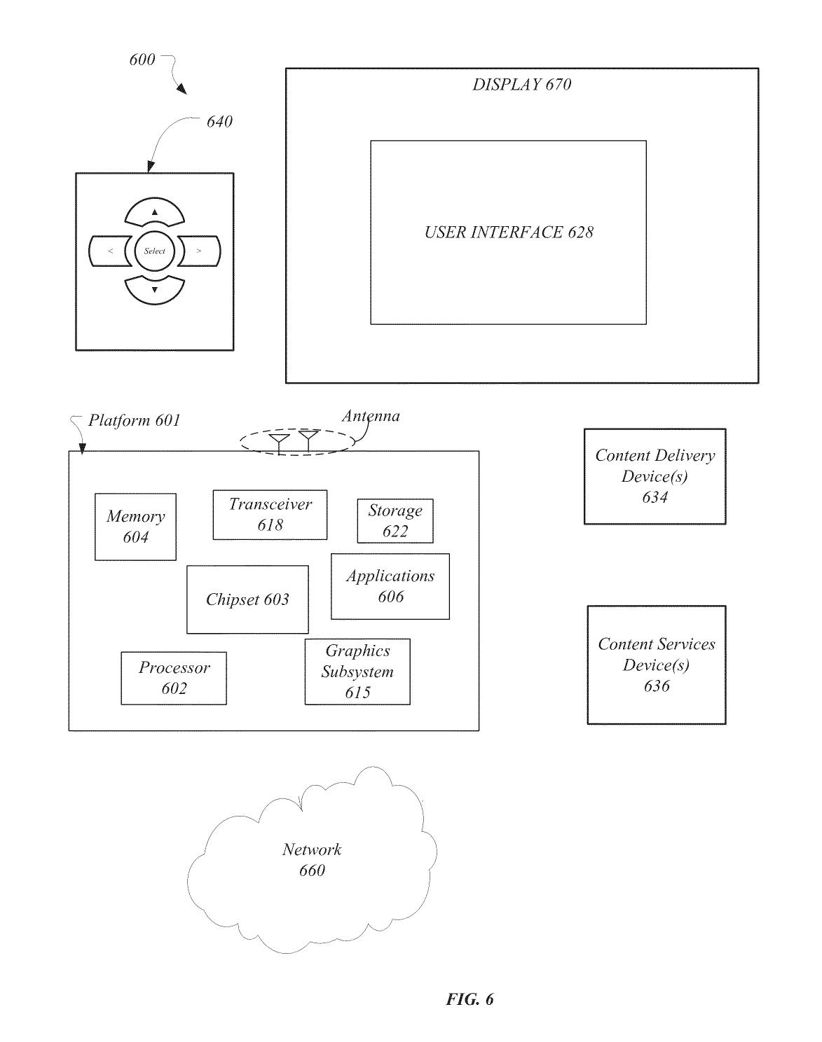

FIG. 6 illustrates an embodiment of a system 600. In various embodiments, system 600 may be operable to execute instructions for improving playback of an audio stream. System 600 may be representative of a system or architecture suitable for use with one or more embodiments described herein, such as apparatus 100 and/or system 150 of FIG. 1, state diagram 200 of FIG. 2, logic flow 300 of FIG. 3, transmission diagram 400 of FIG. 4, or system 500 of FIG. 5. The embodiments are not limited in this respect.

As shown in FIG. 6, system 600 may comprise multiple elements. One or more elements may be implemented using one or more circuits, components, registers, processors, software subroutines, modules, or any combination thereof, as desired for a given set of design or performance constraints. Although FIG. 6 shows a limited number of elements in a certain topology by way of example, it can be appreciated that more or less elements in any suitable topology may be used in system 600 as desired for a given implementation. The embodiments are not limited in this context.

In embodiments, system 600 may be a media system although system 600 is not limited to this context. For example, system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 600 comprises a platform 601 coupled to a display 670. Platform 601 may receive content from a content device such as content services device(s) 634 or content delivery device(s) 636 or other similar content sources. A navigation controller 640 comprising one or more navigation features may be used to interact with, for example, platform 601 and/or display 670. Each of these components is described in more detail below.

In embodiments, platform 601 may comprise any combination of a processor circuit 602, chipset 603, memory unit 604, applications 606, graphics subsystem 615, transceiver 618, and/or storage 622. Chipset 603 may provide intercommunication among processor circuit 602, memory unit 604, applications 606, graphics subsystem 615, transceiver 618, and/or storage 622. For example, chipset 603 may include a storage adapter (not depicted) capable of providing intercommunication with storage 622.

Processor circuit 602 may be implemented using any processor or logic device, and may be the same as or similar to processor circuit 502 in FIG. 5.

Memory unit 604 may be implemented using any machine-readable or computer-readable media capable of storing data, and may be the same as or similar to memory unit 504 in FIG. 5.

Graphics subsystem 615 may perform processing of images such as still or video for display. Graphics subsystem 615 may be a graphics processing unit (GPU) or a visual processing unit (VPU), for example. An analog or digital interface may be used to communicatively couple graphics subsystem 615 and display 670. For example, the interface may be any of a High-Definition Multimedia Interface, DisplayPort, wireless HDMI, and/or wireless HD compliant techniques. Graphics subsystem 615 could be integrated into processor circuit 602 or chipset 603. Graphics subsystem 615 could be a stand-alone card communicatively coupled to chipset 603.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Transceiver 618 may include one or more radios capable of transmitting and receiving signals using various suitable wireless communications techniques, and may be the same as or similar to transceiver 518 in FIG. 5.

Storage 622 may be implemented as a non-volatile storage device, and may be the same as or similar to storage 522 in FIG. 5.

In embodiments, display 670 may comprise any television type monitor or display, and may be the same as or similar to display 570 in FIG. 5.

In embodiments, content services device(s) 634 may be hosted by any national, international and/or independent service and thus accessible to platform 601 via the Internet, for example. Content services device(s) 634 may be coupled to platform 601 and/or to display 670. Platform 601 and/or content services device(s) 634 may be coupled to a network 660 to communicate (e.g., send and/or receive) media information to and from network 660. Content delivery device(s) 636 also may be coupled to platform 601 and/or to display 670.

In embodiments, content services device(s) 634 may comprise a cable television box, personal computer, network, telephone, Internet enabled devices or appliance capable of delivering digital information and/or content, and any other similar device capable of unidirectionally or bidirectionally communicating content between content providers and platform 601 and/display 670, via network 660 or directly. It will be appreciated that the content may be communicated unidirectionally and/or bidirectionally to and from any one of the components in system 600 and a content provider via network 660. Examples of content may include any media information including, for example, video, music, medical and gaming information, and so forth.

Content services device(s) 634 receives content such as cable television programming including media information, digital information, and/or other content. Examples of content providers may include any cable or satellite television or radio or Internet content providers. The provided examples are not meant to limit embodiments of the invention.

In embodiments, platform 601 may receive control signals from navigation controller 640 having one or more navigation features. The navigation features of controller 640 may be used to interact with a user interface 628, for example. In embodiments, navigation controller 640 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 640 may be echoed on a display (e.g., display 670) by movements of a pointer, cursor, focus ring, or other visual indicators displayed on the display. For example, under the control of software applications 606, the navigation features located on navigation controller 640 may be mapped to virtual navigation features displayed on user interface 628, for example. In embodiments, navigation controller 640 may not be a separate component but integrated into platform 601 and/or display 670. Embodiments, however, are not limited to the elements or in the context shown or described herein.

In embodiments, drivers (not shown) may comprise technology to enable users to instantly turn on and off platform 601 like a television with the touch of a button after initial boot-up, when enabled, for example. Program logic may allow platform 601 to stream content to media adaptors or other content services device(s) 634 or content delivery device(s) 636 when the platform is turned “off.” In addition, chip set 603 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 600 may be integrated. For example, platform 601 and content services device(s) 634 may be integrated, or platform 601 and content delivery device(s) 636 may be integrated, or platform 601, content services device(s) 634, and content delivery device(s) 636 may be integrated, for example. In various embodiments, platform 601 and display 670 may be an integrated unit. Display 670 and content service device(s) 634 may be integrated, or display 670 and content delivery device(s) 636 may be integrated, for example. These examples are not meant to limit the invention.

In various embodiments, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 601 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

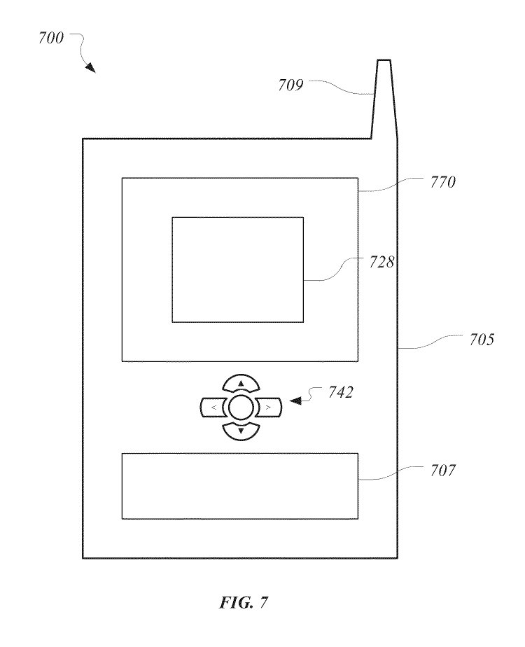

As described above, system 600 may be embodied in varying physical styles or form factors. FIG. 7 illustrates embodiments of a small form factor device 700 in which system 600 may be embodied. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may comprise a housing 705, an input/output (I/O) device 707, an antenna 709, a user interface 728, and a display 770. Device 700 also may comprise navigation features 742, which may be used to interact with user interface 728. Display 770 may comprise any suitable display unit for displaying information appropriate for a mobile computing device. I/O device 707 may comprise any suitable I/O device for entering information into a mobile computing device. Examples for I/O device 707 may include an alphanumeric keyboard, a numeric keypad, a touch pad, input keys, buttons, switches, rocker switches, microphones, speakers, voice recognition device and software, and so forth. Information also may be entered into device 700 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor circuit;
a memory unit communicatively coupled to the processor circuit, the memory unit arranged to store encoded audio data;
an audio transfer module operative on the processor circuit to send a notification of a pending delivery of the encoded audio data stored in the memory unit; and
an audio management module operative on the processor circuit to generate a silent audio data stream for transmission to an audio receiver in response to the notification in order to maintain the audio receiver in an active state.

2. The apparatus of claim 1, the audio management module further operative on the processor circuit to:
receive the encoded audio data stored in the memory unit;
decode the encoded audio data to obtain decoded audio data; and
transmit the decoded audio data to the audio receiver as a decoded audio data stream.

3. The apparatus of claim 2, further comprising an audio controller module operative to receive the encoded audio data from the memory unit and send the encoded audio data to the audio management module based on an initiation of the pending delivery.

4. The apparatus of claim 2, the audio management module further operative on the processor circuit to transmit a previous silent audio data stream to the audio receiver prior to the receipt of the notification.

5. The apparatus of claim 2, the audio management module further operative on the processor circuit to transmit a previous decoded audio data stream to the audio receiver prior to the receipt of the notification, the previous decoded audio data stream in a previous audio format that differs from an audio format of the decoded audio data stream.

6. A system, comprising:
a processor circuit;
a memory unit communicatively coupled to the processor circuit, the memory unit arranged to store encoded audio data;
an audio transfer module operative on the processor circuit to send a notification of a pending delivery of the encoded audio data stored in the memory unit;
an audio management module operative on the processor circuit to generate a silent audio data stream for transmission to an audio receiver in response to the notification in order to maintain the audio receiver in an active state; and
a display communicatively coupled to the processor circuit.

7. The system of claim 6, the audio management module further operative on the processor circuit to:
receive the encoded audio data stored in the memory unit;
decode the encoded audio data to obtain decoded audio data; and
transmit the decoded audio data to the audio receiver as a decoded audio data stream.

8. The system of claim 7, further comprising an audio controller module operable to receive the encoded audio data from the memory unit and send the encoded audio data to the audio management module based on an initiation of the pending delivery.

9. The system of claim 7, the audio management module further operative on the processor circuit to transmit a previous silent audio data stream to the audio receiver prior to the receipt of the notification.

10. The system of claim 6, the audio management module further operative on the processor circuit to transmit a previous decoded audio data stream to the audio receiver prior to the receipt of the notification, the previous decoded audio data stream in a previous audio format that differs from an audio format of the decoded audio data stream.

11. A computer-implemented method, comprising:
initiating, by a processor circuit, a pending delivery of encoded audio data stored in a memory unit;
receiving a notification of the pending delivery; and
transmitting a silent audio data stream to an audio receiver after receiving the notification to maintain the audio receiver in an active state.

12. The method of claim 11, further comprising transmitting a previous silent audio data stream to the audio receiver prior to the receipt of the notification.

13. The method of claim 12, wherein a format of the previous silent audio data stream differs from a format of the silent audio data stream.

14. The method of claim 11, further comprising:
receiving the encoded audio data stored in the memory unit;
decoding the encoded audio data to obtain decoded audio data; and
transmitting the decoded audio data to the audio receiver as a decoded audio data stream.

15. The method of claim 14, further comprising transmitting a previous decoded audio data stream to the audio receiver prior to the receipt of the notification, the previous decoded audio data stream in a previous audio format that differs from an audio format of the decoded audio data stream.

16. An article comprising a computer-readable storage medium containing instructions that when executed cause a computing system to:
initiate a pending delivery of encoded audio data stored in a memory unit;
receive a notification of the pending delivery; and
transmit a silent audio data stream to an audio receiver after receiving the notification.

17. The article of claim 16, further comprising instructions that when executed cause the computing system to transmit a previous silent audio data stream to the audio receiver prior to the receipt of the notification.

18. The article of claim 17, wherein a format of the previous silent audio data stream differs from a format of the silent audio data stream.

19. The article of claim 16, further comprising instructions that when executed cause the computing system to:
receive the encoded audio data stored in the memory unit;
decode the encoded audio data to obtain decoded audio data; and
transmit the decoded audio data to the audio receiver as a decoded audio data stream.

20. The article of claim 16, further comprising instructions that when executed cause the computing system to transmit a previous decoded audio data stream to the audio receiver prior to the receipt of the notification, the previous decoded audio data stream in a previous audio format that differs from an audio format of the decoded audio data stream.
